(19) United States
(12) Patent Application Publication
(10) Pub. No.: US 2007/0050301 A1
(43) Pub. Date: Mar. 1, 2007

(54) System for software license control and method therefore

(76) Inventor: Jo Johnson, Westminster, CO (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(21) Appl. No.: 09/876,693

(22) Filed: Jun. 7, 2001

Related U.S. Application Data
(60) Provisional application No. 60/209,904, filed on Jun. 7, 2000.

(51) Int. Cl. G06F 17/30; G06Q 99/00; G06F 7/00; H04L 9/00; H04K 1/00

(52) U.S. Cl. 705/59; 707/8

(57) ABSTRACT

The present invention provides a system for monitoring the number and usage of licenses of an application over a network. A customer is allotted a certain number of excess licenses that are utilized on an as needed basis. Once one or more of these excess licenses are utilized, a notification is sent to the application representative of these uses. The customer is then billed for these excess licenses. If the customer does not timely pay for these excess licenses, these excess licenses are terminated. If the customer does timely pay, then a new updated license file is transmitted to the customer. The system also is able to remotely audit the customer site for unauthorized usage as well as the usage and trends of the customer. The system is able to operate automatically with no user intervention.

### RELATED APPLICATIONS

This application relates to provisional patent application 60/209,904, filed on Jun. 7, 2001.

### FIELD OF THE INVENTION

This invention relates to the field of monitoring software licenses in a network.

### BACKGROUND OF THE INVENTION

Most applications, such as business software applications, office software suites, database applications, and the like, are licensed to users on a per user basis. There are presently a number of existing license control systems that monitor the number of users using such applications on a network. Once the prescribed number of users are using these applications, the system will shut-down or lock-out additional users to prevent additional users from unauthorized use of the applications.

Thus, when additional users require access to the application, the site administrator must order new software configured for the additional users. This new software must then be re-installed on the network. This delay and interruption can disrupt business operations. Previously, the only solution to minimize such delays was to oversubscribe the number of licensees to the application. This increases the expense of the application.

Thus, a need presently exists to allow uninterrupted increasing of the number of users to an application.

### SUMMARY OF THE INVENTION

The present invention provides a system for monitoring the number and usage of licenses of an application over a network. A customer is allotted a certain number of excess licenses that are utilized on an as needed basis. Once one or more of these excess licenses are utilized, a notification is sent to the application representative of these uses. The customer is then billed for these excess licenses. If the customer does not timely pay for these excess licenses, these excess licenses are terminated. If the customer does timely pay, then a new updated license file is transmitted to the customer.

The system also is able to remotely audit the customer site for unauthorized usage as well as the usage and trends of the customer. The system is able to operate automatically with no user intervention.

These and other features will be evident from the ensuing description of preferred embodiments and from the drawings.

### BRIEF DESCRIPTION OF THE DRAWINGS

FIG. 1 is a overview of the system of the preferred embodiment.

FIG. 2 is a schematic of the License Broker of the preferred embodiment of the present invention.

### DETAILED DESCRIPTION OF PREFERRED EMBODIMENTS

The present invention provides a system and method for monitoring the number and use of licenses in a network system and for allowing selected customers to exceed the number of purchased licenses. In the preferred descriptive embodiment, the system and methods allow the customer to exceed the number of purchased licenses by a percentage and/or a hard maximum without having to reinstall an application. The customer is able to meet their current software needs without interruption.

It is to be expressly understood that the descriptive embodiments set forth herein are intended for explanatory purposes and is not intended to unduly limit the scope of the claimed inventions. Other embodiments and applications not described herein are considered to be within the scope of the claimed inventions.

System Overview

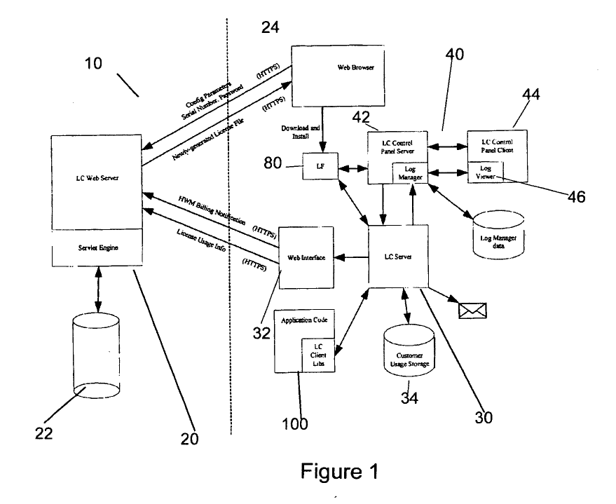

In the preferred embodiment, the system uses a network client server model, as illustrated in FIG. 1. It is to be expressly understood that other types of systems can be used as well, as technology permits. The system 10 of the preferred embodiment includes a server 20, that in the preferred embodiment, resides at a remote location. The License Control Server 30, discussed below and the application 100 for which the license usage is monitored are housed at the customer site.

In the preferred embodiment, the system includes a License Control Component. The License Control Component manages, monitors, stores and controls the application license usage. It is to be expressly understood that for purposes of the present invention, the term application refers to any product, product suite, product version, configuration or any other type of installed product and service. For example, office software products, commercial software applications, Application Shared Products (ASP) and even services, such as customer service, technical support services, can be considered applications for purposes of this invention.

The system further includes an License Allowance Component. The License Allowance Component provides additional features in the License Control Component to maintain counts of the available licenses compared to the purchased licenses, the allowance (amount of excess licenses as discussed in further detail below) that are permitted, and the number of licenses used from the allowance. The License Allowance Component further includes audit capabilities to allow the numbers and usage trends of the licenses to be monitored. A communications link between the server site and the customer site will allow this audit to be performed remotely, and in the preferred embodiment, under encryption. The customer will automatically be billed for any excess licenses and the system updated as necessary.

The License Allowance Component gives selected customers a convenient method of obtaining additional licenses immediately. Values will be stored at the customer site for the number of licenses purchased, their application allowance for additional licenses, the customer defined maximum licenses allowed if any, available licenses compared to the purchased licenses, the number of licenses used from the application allowance and the number of licenses used (at any point in time).

The customer's system will notify the remote server of the license number that they have used from their allowance. The remote server will process the information and subsequently bill the customer for the additional licenses utilized, and update the number of purchased licenses at the customer site. Additionally a feature will be available that allows application representatives to audit the information at a customer site, and generate the notification to the application facilitating customer billing, updating the customer's license information, and generating a new license file for the customer.

The License Allowance Component collects information from the usage of a specific product and maintains a count of the customer usage. Each time a license is requested by the application software, a total usage count is updated. This information will be stored in an encrypted format so that the data can only be viewed by representatives of the licensed application.

Once the customer has exceeded the license count, the License Allowance Component allows them to continue without interruption until the specified amount of additional licenses has been reached. The License Component notifies the customer to inform them that they have started to use the temporary licenses available from application. Once the customer begins to use the allowance, notification is sent via the to the remote server to process the billing and generate a new license file for the customer.

The License Allowance that allows the customer to exceed the purchased licenses is a value defined by the application for each customer that has the License Allowance Component feature. This allowance is a percentage of the purchased licenses that the application will allow the customer to use in addition to licenses the customer has purchased. The customer agrees to purchase the number of licenses that they are already using from their application allowance. Once the number of licenses purchased plus the application allowance total is reached, no further licenses will be granted to the customer from the License Allowance Component functionality. Customers needing more licenses than are granted by the License Allowance Component must utilize the Notify functionality before the License Allowance Component will grant additional licenses, or they may telephone the application representative to purchase additional licenses before the License Allowance Component notifies the remote server. When the customer begins using their license allowance, a timer is set to accumulate the number of additional licenses they are using for a period of two weeks. This total is sent to the remote server, the customer is billed for the extra licenses and subsequently a new license file is sent to the customer.

Some customers may want to control the number of licenses that they allow the system to automatically allocate for them. This value can be entered by the customer at any time and additional usage will be controlled in the same manner that the License allowance is managed.

Once the notification is sent to the remote server, the information will be sent as an offer from the system. From this point an invoice is generated and sent to the customer. The allowance period is a configurable value that will allow the application representative to define the length of time allowed to the customer to pay their invoice. The default value for this is 45 days following the License Allowance Component notification to the remote server.

Following the receipt of payment for the invoice the customer is sent an email with the URL to log into and receive their new license file. If the application representative has not received payment from the customer, at the end of the allowance period, the License Allowance Component allowance is revoked via a time bomb following the allowance period and all the License Allowance Component allowance licenses are suspended. Only the licenses in the License Allowance Component allowance are affected. None of the licenses that the customer has previously purchased is suspended.

Audit Functionality

An audit is periodically performed of the customer utilization data so that the application representative knows when a customer has exceeded the number of licenses that they have purchased. This will be accomplished in two ways:
a representative visits a customer site and manually reviews the information collected by License Allowance Component
the customer's system generates a Notification once the customer has exceeded the purchased licenses

A tool will be provided to allow representatives to view the data at the customer site. This will be an option available from the License Control Control Panel. The representative can review at the data, or request a change to the allowance allowed for that customer.

Once a month the data from the customer license utilization will be sent to the application representative as well. This validates the notification from the customer and will provide marketing with data about a specific customer. The frequency of this notification is configurable by the customer however, the default value is defined at 30 days.

Notification Functionality

On a monthly basis, notification will be sent from the customer to the application representative. The information will contain customer license usage information. This information can be used by marketing to gain knowledge of how customers use their products. This information will be sent to customer Service Representatives via the.

When a customer begins to utilize allowance licenses notifications are generated by License Control to the customer representatives. These notifications inform them that they are now using a temporary license, that an offer has been sent to the remote server and that they will subsequently be billed for this additional license. In addition, if a new license file has not been put on the License Control Server, reminder notices are sent at intervals to the customer representatives informing them of the time remaining on the allowance license.

Additionally notification will be sent to the application representative and the customer once the customer grace period has elapsed. This data will include the counts of the available licenses compared to the purchased licenses, the license allowance, the number of licenses used from the license allowance and the value that the customer has assigned as the maximum licenses allowed. This data will be used to bill the customer for the additional licenses.

Once the information reaches the application representative, the service representative will take the appropriate actions to bill the customer and generate a new license file adjusting the customer's allowance if appropriate, and send the customer the new license file.

New License File Functionality

There are two times that a customer will need a new license file, first when they initially purchase a new product, and second when the customer has purchased additional licenses by either License Allowance Component allowance usage or directly from the application representative.

To receive a new license file the customer will contact the application representative using the URL provided to them. From this form, specific information that is required will be entered by the customer. At that time the new license file will be available for the customer to down load to their server.

For an updated license file the customer will receive an email from the application representative indicating that they should log onto the URL to validate their information and receive the updated license file.

Once a customer receives the new license file from application representative, the file must replace the current file that they are using. The License Control Component will preserve the path that the current license file resides and will overwrite the current file with the new file sent by the application representative maintaining all custom configuration parameters. The previous file will be marked with a new name so that it may be restored if the customer has a problem with the new file.

The system and methods of the present invention are able to be utilized with little or no user intervention. The notification and billing processes can be handled by an automated customer service database.

Implementation

The system, in a preferred embodiment, is implemented as shown in FIG. 1. The system includes the Server 20 at a remote site, License Control Component 30, and client application 100, as shown in FIG. 1. It is to be expressly understood that this implementation is described for explanatory purposes only and is not meant to limit the scope of the present invention. The system of the present invention is designed to be used on multiple platforms and on all hardware systems where applicable. The system and processes of the present invention are intended for use on not only existing technology including technology not specifically enumerated herein but on developing technology as well.

License Control Component Server 20

The Server 20 resides at a remote site and is used to allow customers to register their product, configure their site information and download their license file. The Server 20, in this preferred descriptive embodiment, runs Microsoft IIS with Secure Socket Layer (SSL) capabilities, and on other server applications as well. All communications from browsers or the License Control Component Server, discussed below, on the customer site will transpire using SSL, if security is desired or other communication applications.

Deployed on the Server 20 are a set of forms for customer registration, updates, and downloads of new license files. Note that the chief aim of these forms is to facilitate the creation and download of new license files to the customer site. When a customer registers one or more products or updates any pertinent information related to their records, a new license file is generated and downloaded to their system. Customer registration encompasses the creation of new user names and passwords, validation of customer serial numbers, and entry of essential customer information including server data and email addresses. Updates include modifications of any of the aforementioned data.

Interface

Java servlets, are used to implement the business logic and extend the functionality of the Server. These servlets provide several features in the design. They manage the registration and verification of customer data, interact with the database through the JDBC API, are responsible for the generation and download of newly-created customer license files, and receive customer usage data on a periodic basis. Other types of applications can be used to accomplish these and/or other functions of the system as well.

Database Backend

The system, at the Server 20, includes a customer database 22 attached to the back end of the Server. The architecture of this database includes the ability to add data to the License Control Component. Procedures will be used between the forms and the database, and will be accessed through the JDBC API, executed by the servlets mentioned above or by other applications.

Customer Configuration and Installation of License File

In order for the customer to receive a valid license file, information must be configured to contain specific information to the customer's environment. To provide this information the customer will log into the Server by browser 24 shown in FIG. 1 and complete that configuration at the initial installation of the product and again when anything changes in their status e.g. they have purchased additional licenses.

This provide a flexible way for customers to configure their server setup and obtain new license files.

As denoted in FIG. 1, the customer logs in to the Server located at a remote site. Upon entering login information, such as user name and password, the customer is presented with a screen where a serial number may be entered and validated. If any errors are incurred, an appropriate form is displayed indicating the source of error.

On a subsequent form, the customer has the option of entering new server information (server name, server hostid, server port) before retrieving the newly-generated license file. This is the same path that is followed for obtaining new license files for newly-purchased licenses, whether License Allowance licenses or entirely new licenses.

Installation of a License File

An applet is provided to automate the download and installation of the new license file 80. This applet incorporates a merging utility for combining the new license file with the existing customer nodelock data. The merging utility will update the ENTERED dates for any License Allowance licenses that the customer purchased. In addition, when the customer enters the location for storing the license file (this may be done at the time the customer enters the new server information), this path data is sent back to the Server and stored in the new license file. If previous path information is found (meaning that the License Control Component had been installed previously), the applet goes to the previous license file path and writes a time-bomb for the previous server before installing the new license file allowing the customer to restore the previous file should there be any problem with the new one.

License Control Component Server 30

The License Control Component Server 30 provides the engine to service the client license control. The License Control Component Server is the command center for monitoring and reporting License Allowance usage. The Server not only maintains all of the licensing data, it also keeps track of License Allowance pools, periods of usage (TimeBombs for License Allowance), and notifications to the application representative and customer.

The internal architecture of the License Control Component Server of the descriptive preferred embodiment is shown in FIG. 1. The pools include: Nodelock List, Nodelock Pool, Runcount Pool, and License Allowance Pool. Nodelock List contains all licenses which are locked to a particular machine or user (some form of nodelock restriction) but are not runcounted. The Nodelock Pool contains all licenses which have a nodelock restriction and are runcounted. The Runcount Pool contains pure runcounted licenses. Finally, the License Allowance Pool is an extension of the Runcount Pool. If users fall through the Runcount Pool, they land in the License Allowance Pool.

License Allowance Pool Functionality

When the License Allowance pool is entered, the License Control Component Server generates three emails and one transmission. Other types of electronic messaging can be used as well. One email goes to the designated customer Accounts Payable (AP) person and one email goes to the site administrator (SA) to indicate that they have used a License Allowance license and that they have X number of days for this usage.

The other email goes to an application representative as notification of customer License Allowance usage. The transmission over HTTP is sent from the License Control Component Server to the application representative to be added in the database. In addition, timers start ticking the moment the customer enters the License Allowance pool.

Subsequent emails are generated to inform the site administrator of the number of days remaining on the License Allowance license. This notification is sent at weekly interval. During the last week remaining on the timebomb emails are generated both to the SA and the AP customer's personnel.

If a new license file has not been received before the License Allowance timebombs expire, the License Allowance pool is disabled. Additional emails are generated at this time to the SA, AP and to the application Rep.

License Reclamation

Other points of interest revolve around the use cases for server reclamation of licenses which include:
Normal check-in. During check-in, client will pass License ID which will uniquely identify the checked-out license.
Client Abort (server in normal mode). IP address and port number will be used to determine which license to reclaim.
Client Abort (server in recovery mode). Client continues to send heartbeats. When the client detects that the server is down, it will send heartbeats with License IDs. The server will use these for license cleanup.
   License Control Component Control Panel

The License Control Component Control Panel 40 provides a means for the customer to configure their license information. The License Control Component Control Panel, in the descriptive preferred embodiment is a unified interface for server configuration, client node-locking configuration, and startup/shutdown of the License Control Component Server.

The License Control Component Control Panel is designed as a Client-Server application. The client portion is a JavaBean, which may be plugged into the Administration Console (AC) Client or run as a standalone frame. Of course, other types of applications can be used to operate the License Control Component Control Panel as well.

For Client-Server applications using both the AC and License Control the administration of both AC and License Control Component will be through the AC Client. Applications that do not utilize the AC will employ the standalone frame. One other note is that the License Control Component Control Panel Server 42 is a client to the License Control Component Server, using the Visibroker ORB or other types of applications for its communications medium.

Regardless of the underlying framework, the License Control Component Control Panel Client must, at the minimum, support the following operational categories: startup/shutdown of server, configuration of server properties, configuration of Nodelock Pools and Lists, configuration of customer parameters (such as email parameters, customer Max), Manual Sync, Log Viewer, and Log Options.

Startup/Shutdown of Server

Start/Stop buttons are used to control the server. These buttons reside on the License Control Component Control Panel.

Configuration of Server Properties

The properties for the Eventlog.properties and License Control ComponentOptions.properties are merged into the existing License Control Component.properties file. The License Control Component Control Panel must be able to configure the following properties:

HB_INTERVAL # Client Heartbeat rate in seconds

HB_RETRIES# Client number of HB retries if server goes down

Configuration of Nodelock Pools and Lists

Customers are able to configure their Nodelock Pools and Nodelock Lists. The user should be able to see the original purchased licenses (the SN, runcount, etc) and the existing Nodelock Pools and Nodelock Lists if these were configured earlier.

If the user wants to reserve a pool/list from the original purchased licenses, the user simply selects the appropriate line, clicks an “ADD” button, and fills out a form in a dialog. This information gets stored with the license file for the License Control Component Server's use.

Editing and removal of existing pools/lists may be accomplished in a similar manner. Again this information updates the license file for the License Control Component Server's use.

Configuration of Customer Parameters

Customers are able to configure email information and define their customer Max values in this scenario. Email information includes; email server name, email server user name, and email server password. These three items are configured by the customer before they use the License Control Component in this descriptive embodiment. Customer Max values may be defined for each product. The configuration of these max values may follow a similar strategy as employed for Nodelock Pools and Lists detailed above.

Manual Sync

This piece of the License Control Component Control Panel Client allows both the Auditor and the customer to manually synchronize the customer Usage information with the application representative. When the Auditor arrives at the customer site, he/she first synchronizes all customer data before logging in to the Server to retrieve a history of customer Usage. This feature is also available to the customer in the case that they need to sync the data for any reason.

Log Viewer

The Log Viewer 46 displays a listing of log events for the administrator. Detailed information will be presented including the application name, date/time, severity, and a description of the event.

Log Options

Filters for logging and viewing will be set in this feature. These filters define the types of events to log or view based on the severity of the event.

License File

The license file contains information specific to products the customer has purchased and the configuration of those products. The license file is generated on the Server and downloaded by the customer to their License Server.

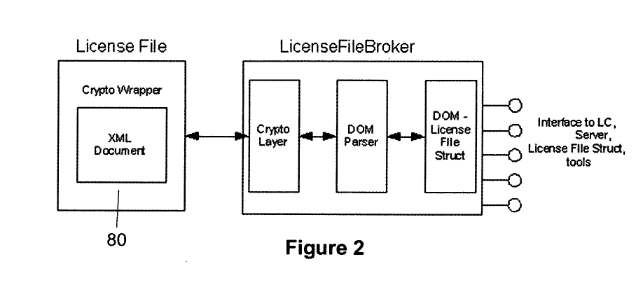

The License File (LF) 80, shown in FIG. 2, holds the configuration for the License Control Component, capturing information regarding the customer's purchased licenses for the products. The amount of configuration information has expanded many times over, as will be seen below. In future versions, this trend will only continue.

The LF architecture is flexible to change and able to accommodate new data requirements without bending backwards. An XML-based representation of the data implemented. With XML, (using own tags) the data types, structures, and order of the document are defined in a Document Type Definition (DTD), a specification or blueprint of the model. Using this DTD, a validating XML parser is able to perform the low-level parsing and validation. When data requirements change, only the DTD is updated, not the parser. The same parser takes in the new XML document and new DTD and performs its operations as before.

A Java XML parser is used for the Server back-end, the License Control Component Server, and other participating tools.

As described in FIG. 2, a LicenseFileBroker is built that encapsulates the parser and the DOM, and exposes an API to the other components. The API exposes the elements in the DOM.

LicenseFile Broker

The LicenseFileBroker implements two interfaces: one for Company use and one for customer use. Company use includes writing the fixed parameters, and vice versa. Additional pieces, shown in FIG. 2 are the Crypto Wrapper of the License File and the Crypto Layer of the LicenseFileBroker. This added layer of security is intended to hide licensing data from plain view.

Interface

The interface is used to transfer information between the License Control Component Server and the Company Server. The Interface provides an interface between the License Control Component Server and the License Control Component Server for sending customer Usage, and License Allowance utilization information.

The Interface 32, shown in FIG. 1, is a component of the License Control Component Server that speaks HTTPS in its communications to Server. The SSL portion maintains the confidentiality and integrity of the transmission by using encryption, authentication, and message authentication codes, while the HTTP URL connection allows a communications channel to be opened up with the servlet on the Server.

Customer Usage Storage

Customer Usage data is provided to allow the application representative a view of how the product is used. The Customer Usage information is stored 34 in a secure fashion. This data is then sent the to the Server at a configurable time frame. Once this data has been sent to the Server, the file at the customer's site should be purged. By default, this data is sent to the Server on a monthly basis.

The License Control Component Server will accumulate the license usage for any of the products at a customer site. This information will consist of lines of data that record the peak usage count for each serial number per day.

Based on the configured time frame the License Control Component Server will prepare the data and transmit it to the Server. Once the data has been transmitted, the file is purged and accumulation continues for the product.

The above description of an example of application of licensing control systems in the present invention has been presented for the purposes of illustration and description only. It is not intended to be exhaustive or to limit the invention to the precise form disclosed. This invention is to be limited only by the following claims, which include all such embodiments when viewed in conjunction with the above specification and accompanying drawings.

1. A method for controlling the number of uses of a licensed application, the system comprising:
providing a first predetermined number of allowed licenses of an application;
providing a second predetermined number of licenses of the application;
monitoring the number of actual uses of an application;
allowing one or more of said second predetermined number of licenses to be utilized once said first predetermined number of allowed licenses have been used; and
notifying a remote site of said utilization of one or more of said second predetermined licenses.

2. The method of claim 1 wherein said step of monitoring the number of actual uses of an application includes:
providing a total usage count for the application;
updating said total usage count each time a license is requested by the application.

3. The method of claim 1 wherein said step of monitoring the number of actual uses of an application includes:
encrypting the number of actual uses of an application.

4. The method of claim 1 wherein said step of notifying a remote site of said utilization of one or more of said second predetermined licenses includes:
notifying a remote site to process billing for additional licenses.

5. The method of claim 1 wherein said method further comprises:
terminating the use of said allowed licenses of said second predetermined licenses if permission for said allowed licenses of said second predetermined licenses is revoked.

6. The method of claim 1 wherein said method further comprises:
periodically auditing the utilization of said second predetermined licenses.

7. The method of claim 1 wherein said method further comprises:
providing a client-server network for implementing said method.

8. A system for controlling the number of uses of a licensed program, the system comprising:
a first license component for providing a predetermined number of allowed licenses of an application;
a second license component for providing a second predetermined number of licenses of the application;
a monitoring component for monitoring the number of actual uses of an application;
an allowance component for allowing one or more of said second predetermined number of licenses to be utilized once said first predetermined number of allowed licenses have been used; and
a notification component for notifying a remote site of said use of said second predetermined licenses.

9. The system of claim 8 wherein said monitoring component includes:
a total usage count for the application;
an updating component for updating said total usage count each time a license is requested by the application.

10. The system of claim 8 wherein said monitoring component includes:
an encryption component for encrypting the number of actual uses of an application.

11. The system of claim 8 wherein said notification component includes:
a component for notifying a remote site to process billing for additional licenses.

12. The system of claim 8 wherein said system further comprises:
a component for terminating the use of said allowed licenses of said second predetermined licenses if permission for said allowed licenses of said second predetermined licenses is revoked.

13. The system of claim 8 wherein said system further comprises:
a component for periodically auditing the utilization of said second predetermined licenses.

14. The system of claim 8 wherein said system further comprises:
a client-server network.
